(19) United States
(12) Patent Application Publication
(10) Pub. No.: US 2025/0282685 A1
(43) Pub. Date: Sep. 11, 2025

(54) Self-levelling compound with high moisture resistance

(71) Applicant: UZIN UTZ SE, Ulm (DE)

(72) Inventors: Johannis TSALOS, Ulm (DE); Hans-Georg EISENMANN, Ulm (DE); Timo JOECHLE, Ulm (DE)

(73) Assignee: UZIN UTZ SE, Ulm (DE)

(21) Appl. No.: 19/075,306

(22) Filed: Mar. 10, 2025

(30) Foreign Application Priority Data
Mar. 11, 2024 (EP) 24162613.4

(51) Int. Cl. C04B 28/14; C04B 14/06; C04B 111/27

(52) U.S. Cl. CPC C04B 28/146; C04B 14/06; C04B 2111/27

(57) ABSTRACT

The present invention relates to a self-levelling compound with high moisture resistance.

### FIELD OF THE INVENTION

The invention relates to a self-levelling compound with high moisture resistance.

### STATE OF THE ART

When installing floor coverings, levelling of the subfloor is often necessary to prepare the subfloor, both in new constructions and renovations. Powder products or dry mortar are inter alia used for this purpose, which only need to be mixed with a certain amount of water on the construction site. If the floor levelling compound applied to the subfloor is processed correctly, it provides a suitably even surface for bonding floor coverings (e.g. PVC, linoleum, rubber, parquet, ceramic tiles).

A division of commercially available levelling compounds can be made on the basis of the binder used. In addition to dispersion levelling compounds and reaction resin levelling compounds, which are often very expensive and therefore reserved for special applications, levelling compounds based on inorganic binders (e.g. cement levelling compounds and calcium sulphate levelling compounds) are used in a much wider range of applications.

Nowadays, binder systems consisting of calcium sulphate agents (alpha-hemihydrate, beta-hemihydrate, anhydrite or mixtures thereof) in combination with one or more cements (Portland cement, calcium aluminate cement or calcium sulfoaluminate cement) are usually used in the formulation of self-levelling compounds for floors. By combining the binders described above, important properties such as setting and hardening time, early strength development, low shrinkage etc. can be adjusted.

Depending on whether the underlying binder system contains more calcium sulphate agents or more cement, it is referred to as a CaSO₄-based levelling compound or a cement-based levelling compound. The binder used in excess can be referred to as the main binder and the other binder components as secondary binders. A definition of CaSO₄-based levelling compounds and cement-based levelling compounds is given in TKB-Merkblatt 9, July 2019, chapter 4.1.

Conventional self-levelling compounds for floors that contain cement (Portland cement, calcium aluminate cement or calcium sulfoaluminate cement) as the main binder tend to shrink more than calcium sulphate levelling compounds and therefore have a lower dimensional stability. This often means a higher risk of crack formation for the surfaces made from these levelling compounds. In addition, these levelling compounds contribute to an increased GWP (Global Warming Potential) due to their cement content.

In contrast, cement levelling compounds are more moisture-resistant, which is why TKB-Merkblatt 9 explicitly states that CaSO₄ levelling compounds must not be used in outdoor areas or wet areas such as bathrooms. The reason for the lack of moisture resistance of CaSO₄ levelling compounds is primarily due to the fact that the needle-shaped and interlocking gypsum crystals, which are primarily formed when the levelling compound sets or dries, separate from each other when additional water is added. It is known that gypsum is water-soluble and that strength is lost through water induction.

For this reason, the development of moisture-resistant CaSO₄-based levelling compounds has become important. The documents WO 2014/108436 A1, WO 2014/108434 A1, WO 2015/062749 A1, DE 10 2013 200 119 A1 and DE 10 2013 200 121 A1 describe CaSO₄-based binders that exhibit a certain degree of moisture resistance. However, these binders also contain Portland cement, calcium aluminate cement or calcium sulfoaluminate cement, which can lead to reduced dimensional stability and an increased GWP value. The same applies to the compositions described in US 2019/0062216 A1 and DE 10 2021 125 435 A1.

All formulations of CaSO₄ levelling compounds known in the literature also contain Portland cement, calcium aluminate cement and/or calcium sulfoaluminate cement as secondary binders and therefore generally have either no dimensional stability or a relatively high GWP value. There is therefore a need to develop a self-levelling compound with improved moisture resistance, as well as increased dimensional stability and a low GWP value.

### SUMMARY OF THE INVENTION

In a first aspect, the present invention provides a self-levelling compound consisting essentially of 30 to 40 wt % of a first binder, 10 to 20 wt % of a second binder, 40 to 59 wt % of at least one filler and >0 to 5 wt % of additives and/or other constituents, based on the dry weight of the levelling compound. The weight ratio of the first binder to the second binder is 2:1 to 3.5:1. Furthermore, the first binder is alpha calcium sulphate hemihydrate and the second binder comprises 35 to 50 wt % CaO, 25 to 45 wt % SiO₂, 2 to 7 wt % water, 0 to <1 wt % Fe₂O₃, 0 to <2 wt % Al₂O₃ and 0 to <2 wt % SO₃, based on the total weight of the second binder.

Surprisingly, the inventors have discovered that such a levelling compound has both increased moisture resistance and improved dimensional stability. This means that the levelling compound can be used in wet areas. By using the second binder, Portland cement, calcium aluminate cement or calcium sulfoaluminate cement can also be omitted, so that the GWP value of the levelling compound can be significantly reduced.

In a further aspect, the present invention provides the use of a levelling compound according to the first aspect for levelling floor bases having a residual moisture content of up to 5 CM % as measured by the CM method or 99% RH as measured by the KRL method. As described above, the levelling compound can be used on such bases due to its moisture resistance. The dimensional stability of the levelling compound can also prevent crack formation on bases with residual moisture.

Further aspects of the present invention can be found in the dependent claims and the detailed description.

### DETAILED DESCRIPTION OF THE INVENTION

### Definitions

Unless defined otherwise, technical and scientific terms used herein have the same meaning as commonly understood by one of ordinary skill in the art to which this invention belongs.

Amounts within the present invention are given in wt %, unless stated otherwise or clear from context.

The term “self-levelling” is not particularly limited in the context of the present invention. In particular, “self-levelling” and “self-flowing” may be used interchangeably in the context of the present invention. As is generally known, “self-levelling” means that a levelling compound mixed with water spreads on a subfloor independently or by its own weight and the characteristic flow behavior, largely with little manual force of the applicator, and forms a flat surface. Levelling compounds with self-levelling properties are commercially available and are known in the state of the art. Self-levelling compounds are suitable for use in levelling subfloors and, in particular, in preparation for the subsequent installation of a floor covering. In certain embodiments, a levelling compound is self-levelling if it has the ability to spread under its own weight. According to some embodiments, a levelling compound is self-levelling if the levelling compound has an efflux time of at most 70 s and a flow spread of at least 11 cm, measured with a flow cup according to DIN 53211:1987-06 with a 6 mm nozzle. To measure the efflux time and flow spread, the levelling compound is mixed with water. 18 to 22 wt % of water may be added to the dry levelling compound, based on the dry weight of the levelling compound. “Dry” means that the levelling compound has not been mixed with water. According to some embodiments, a flow cup according to DIN 53211:1987-06 is used to measure the efflux time and the flow spread, with the difference that a 6 mm nozzle is used instead of the 4 mm nozzle specified in DIN 53211:1987-06. A detailed description of the measurement of the efflux time and the flow spread is given below.

The term “levelling” is not particularly limited in the context of the present invention. As is generally known, “levelling” refers to the process of producing a flat and homogeneous surface by applying a floor levelling compound or screed compound to a floor or subfloor. The object of levelling is to create an even, load-bearing basis for subsequent flooring installation or other construction applications. Levelling typically involves mixing the screed compound with water according to the manufacturer's instructions, applying the liquid compound using appropriate tools and techniques to ensure even distribution, and then smoothing the surface until the desired flatness is achieved.

The term “dry weight” is not particularly limited in the context of the present invention. According to some embodiments, the term “dry weight” refers to the weight of the powder and/or dry levelling compound. In some embodiments, “powder levelling compound” means that the levelling compound has not been mixed with water.

The term “self-levelling compound” is not particularly limited in the context of the present invention. According to certain embodiments, the “self-levelling compound” refers to a dry mix and/or powder mix of a levelling compound before it is mixed with water.

“Levelling compound” is not particularly limited in the context of the present invention. In some embodiments, the levelling compound is a floor levelling compound. According to certain embodiments, the levelling compound is a screed compound. In particular, the levelling compound of the present invention may be a CaSO₄-based or calcium sulfate bound levelling compound as defined in TKB Merkblatt 9, July 2019, Chapter 4.1. When the term “levelling compound” is used in the context of the present invention, it refers to a self-levelling compound.

The term “mixing” is not particularly limited in the context of the invention. As is generally known, the mixing of levelling compounds refers to the mixing of the dry levelling compounds with water. Usually, the amount of water for mixing the levelling compound is specified by the manufacturer. The water for mixing the levelling compound is also referred to as “mixing water” or “addition water” and refers to the water that must be added during the mixing and preparation of the levelling compound in order to make it workable and to initiate the setting process. According to certain embodiments, the terms “mixing” and “blending” are equivalent.

In the context of the present invention, the abbreviation “GWP” means “Global Warming Potential”. The GWP value of a chemical compound, a component or a mixture is a measure of its relative contribution to the greenhouse effect. GWP is generally understood to be the sum of all greenhouse gases absorbed or emitted over the considered phases of the product life cycle. The greenhouse gas flows are converted into the common unit: kg CO₂-equivalents/kg and added up. The product-specific GWP is calculated according to the calculation rules of the DIN EN 15804:2012+A2:2019 standard. The life cycle phases A1 to A3 of the standard may be considered and both primary and secondary data may be included. In some embodiments of the present invention, the GWP value is determined according to DIN EN 15804:2012+A2:2019.

In the context of the present invention, the term “residual moisture” refers to the amount of water vapor or moisture present in the floor base. In particular, residual moisture may refer to the amount of water vapor or moisture remaining in the subfloor after a drying phase of the subfloor. Residual moisture in this context does not refer to “emerging moisture”. “Emerging moisture” means that water vapor from layers below, such as the concrete in contact with the ground for the house foundation, can migrate upwards via the adjacent layers above, such as the screed, into the corresponding installation material layers, such as the primer, the levelling compound and the adhesive. In addition, it is understood that the concrete or screed surface adjacent to the overlying installation materials to be applied, such as the levelling compound according to the invention and the primer applied prior to levelling, must not contain any liquid water.

A first aspect of the invention relates to a self-levelling compound consisting essentially of 30 to 40 wt % of a first binder, 10 to 20 wt % of a second binder, 40 to 59 wt % of at least one filler and >0 to 5 wt % of additives and/or other constituents, based on the dry weight of the levelling compound. The weight ratio of the first binder to the second binder is 2:1 to 3.5:1. Furthermore, the first binder is alpha calcium sulphate hemihydrate (α-CaSO₄·0.5H₂O) and the second binder comprises 35 to 50 wt % CaO, 25 to 45 wt % SiO₂, 2 to 7 wt % water (H₂O), 0 to <1 wt % Fe₂O₃, 0 to <2 wt % Al₂O₃ and 0 to <2 wt % SO₃, based on the total weight of the second binder.

In extensive studies, the inventors have surprisingly found that the above-mentioned composition according to the invention provides a levelling compound which is both moisture-resistant and dimensionally stable, has a low GWP value and has self-levelling properties. This can be achieved in particular by the specific mixture of the first and second binder, whereby the addition of Portland cement, calcium aluminate cement and calcium sulfoaluminate cement can be dispensed with.

The “other constituents” of the self-levelling compound refer to constituents that do not fall under the categories of binders, fillers or additives and may be commonly found in levelling compounds and in particular gypsum-based levelling compounds.

The details of the components of the second binder are to be understood in such a way that “CaO”, “SiO₂”, “SO₃” and optionally also “Fe₂O₃” and “Al₂O₃” refer to their contents in the binder. This means that the components mentioned may be at least partially or completely bound in a compound such as a mixed oxide or a phase such as a C—S—H phase. Accordingly, the components of the second binder may also be specified as contents, e.g. by the specifications “35 to 50 wt % CaO contents”, “25 to 45 wt % SiO₂ contents”, “0 to <1 wt % Fe₂O₃ contents”, “0 to <2 wt % Al₂O₃ contents” and “0 to <2 wt % SO₃ contents”.

In the context of the present invention, the expression “consisting essentially of” means that, in addition to the constituents of the levelling compound mentioned in the claim, additional components may be present in small quantities as long as they do not have a significant influence on the function and performance of the levelling compound according to the invention. By “function” and “performance” are meant in particular the self-levelling properties, moisture resistance and dimensional stability. “Small amounts” means amounts of at most 5 wt %, preferably at most 2.5 wt % and more preferably at most 1 wt %, based on the dry weight of the levelling compound. In particular, the self-levelling compound may consist of the first binder, the second binder, the at least one filler and the additives and/or other constituents, wherein the specified weight percentages (wt %) add up to a total of 100 wt %, based on the dry weight of the levelling compound.

In some embodiments, the levelling compound is a CaSO₄-based levelling compound. In certain embodiments, the self-levelling compound comprises 30 to 40 wt % of the first binder, 10 to 20 wt % of the second binder, 40 to 59 wt % of the at least one filler and >0 to 5 wt % of the additives and/or other constituents, based on the dry weight of the levelling compound, wherein the stated weight percentages (wt %) add up to a total of 100 wt %. According to preferred embodiments, the levelling compound consists or consists essentially of 33 to 38 wt %, more preferably 35 to 37 wt % of the first binder, 12 to 18 wt %, more preferably 15 to 17 wt % of the second binder, 42 to 50 wt %, more preferably 43 to 48 wt % of the at least one filler and 0.5 to 4.0 wt %, more preferably 1.5 to 3.5 wt % of the additives and/or other constituents, based on the dry weight of the levelling compound. According to preferred embodiments, the weight ratio of the first binder to the second binder is 2.1:1 to 2.5:1. In these embodiments, the above-mentioned advantages and effects are particularly pronounced.

In some embodiments, the second binder consists of 35 to 50 wt % CaO, 25 to 45 wt % SiO₂, 2 to 7 wt % water (H₂O), 0 to <1 wt % Fe₂O₃, 0 to <2 wt % Al₂O₃ and 0 to <2 wt % SO₃, based on the total weight of the second binder. In preferred embodiments, the second binder comprises or consists of 35 to 45 wt %, preferably 37 to 41 wt % CaO and 35 to 45 wt %, preferably 37 to 41 wt % SiO₂, 2.1 to 5.0 wt %, more preferably 2.2 to 4.0 wt % water, >0 to <1 wt %, more preferably 0.01 to 0.5 wt % Fe₂O₃, >0 to <2 wt %, more preferably 1.0 to 1.8 wt % Al₂O₃ and >0 to <2 wt %, more preferably 0.5 to 1.0 wt % SO₃, based on the total weight of the second binder. If the second binder consists of the components or contents mentioned, the stated weight percentages add up to 100 wt %, based on the total weight of the second binder. In these embodiments, the moisture resistance of the levelling compound is further increased and the dimensional stability is further improved.

In some embodiments, the second binder is prepared by a method comprising mixing CaO, CaCO₃ and/or Ca(OH)₂ with SiO₂ and/or siliceous materials to obtain a mixture, optionally calcining the mixture at 700° C. to 800° C. to obtain a calcined mixture, hydrothermally treating the mixture or calcined mixture for 2 to 10 hours at 140° C. to 300° C. and optionally at a pressure of 16 to 40 bar to obtain a product, optionally drying the product for 12 to 16 hours at 60° C. to 90° C. to obtain a dried product and further optionally grinding the product or dried product to obtain a powder. The product, the dried product and/or the powder may be the second binder. In preferred embodiments, the powder is the second binder. The siliceous materials may be selected from the group consisting of quartz, silica, kaolin, mica, feldspar, glasses and combinations thereof. In preferred embodiments, the hydrothermal treatment is carried out for 4 to 8 hours and/or at a temperature of 180° C. to 220° C. and/or at a pressure of 18 to 25 bar. Further, the hydrothermal treatment may be carried out in saturated water vapor. The grinding step may involve adding quartz sand to the product or dried product. The quartz sand may be added in a weight ratio of 1:1 quartz sand:product or dried product.

According to some embodiments, the second binder is a calcium hydrosilicate-based binder. In certain embodiments, at least a portion of the CaO, the SiO₂ and the water in the second binder is present as calcium hydrosilicate. The calcium hydrosilicate may comprise α-Ca₂[HSiO₄]OH, Ca₅[HSi₂O₇]₂·8H₂O and/or Ca₆[Si₂O₇](OH)₆ or consist of α-Ca₂[HSiO₄]OH, Ca₅[HSi₂O₇]₂·8H₂O and/or Ca₆[Si₂O₇](OH)₆. In particular, the calcium hydrosilicate may comprise α-Ca₂[HSiO₄]OH and Ca₆[Si₂O₇](OH)₆. For example, a portion of the CaO, the SiO₂ and the water may be present as calcium hydrosilicate, while a portion of the CaO and the SiO₂ may be present as unreacted starting products of the preparation of the second binder described above and a portion of the water may be present unbound and/or as residual moisture. Some of the calcium atoms and the silicon atoms of the calcium hydrosilicates may be replaced by iron and/or aluminum atoms.

According to certain embodiments, the second binder consists essentially of calcium hydrosilicates. This means that in some embodiments the second binder has a content of calcium hydrosilicates of at least 70 wt %, preferably at least 80 wt % and particularly preferably at least 90 wt %, based on the total weight of the second binder. The remaining contents of the second binder may be quartz sand, calcium oxide and/or calcium carbonate. The “remaining contents” refer to the contents which, together with the above-mentioned contents of calcium hydrosilicate, make up 100 wt %, based on the total weight of the second binder. The calcium hydrosilicates may comprise α-Ca₂[HSiO₄]OH, Ca₅[HSi₂O₇]₂·8H₂O and/or Ca₆[Si₂O₇](OH)₆. In some embodiments, the calcium hydrosilicates are selected from the group consisting of α-Ca₂[HSiO₄]OH, Ca₅[HSi₂O₇]₂·8H₂O, Ca₆[Si₂O₇](OH)₆ and combinations thereof. Some of the calcium atoms and the silicon atoms of the calcium hydrosilicates may be replaced by iron and/or aluminum atoms.

According to some embodiments, the second binder is partially amorphous. In this context, “partially amorphous” means that the second binder has an amorphous portion. In particular, the second binder may comprise an amorphous portion and a crystalline portion. The amorphous portion may comprise amorphous phases and the crystalline portion may comprise crystalline phases. In some embodiments, the second binder has an amorphous portion of 50 to 90 wt %, preferably 60 to 80 wt % and particularly preferably 70 to 77 wt %, based on the total weight of the second binder. This means that the second binder may have amorphous phases in a content of 50 to 90 wt %, preferably 60 to 80 wt % and particularly preferably 70 to 77 wt %, based on the total weight of the second binder. The content of amorphous phases in the second binder or the amorphous portion of the second binder is determined by Rietveld analysis or, more precisely, by powder diffraction and Rietveld analysis. In these embodiments, the above-mentioned advantages and effects are particularly pronounced.

In some embodiments, the self-levelling compound is essentially free of Portland cement, calcium aluminate cement and calcium sulfoaluminate cement. “Substantially free of Portland cement, calcium aluminate cement and calcium sulfoaluminate cement” herein means that the content of Portland cement, calcium aluminate cement and calcium sulfoaluminate cement in the self-levelling compound is at most 1 wt %, preferably at most 0.5 wt % and particularly preferably at most 0.1 wt %, based on the dry weight of the self-levelling compound. According to certain embodiments, Portland cement has the chemical composition 18-25 wt % SiO₂, 2-6 wt % Al₂O₃, 1-4 wt % Fe₂O₃, 62-69 wt % CaO, 2-5 wt % SO₃, based on the total weight of the Portland cement. In particular, Portland cement may have the chemical composition 21-24 wt % SiO₂, 3-5 wt % Al₂O₃, 1-2 wt % Fe₂O₃, 63-68 wt % CaO, 3-4 wt % SO₃ or 19-20 wt % SiO₂, 5-7 wt % Al₂O₃, 2-3 wt % Fe₂O₃, 63-64 wt % CaO, 3-4 wt % SO₃, based on the total weight of the Portland cement. In some embodiments, calcium aluminate cement has the chemical composition 36-44 wt % Al₂O₃, 34-42 wt % CaO, 2-8 wt % SiO₂, 12-20 wt % Fe₂O₃, based on the total weight of the calcium aluminate cement. In particular, calcium aluminate cement may have the chemical composition 4-6 wt % SiO₂, 38-42 wt % Al₂O₃, 13-17 wt % Fe₂O₃, 36-40 wt % CaO or 3-5 wt % SiO₂, 38-42 wt % Al₂O₃, 14-18 wt % Fe₂O₃, 35-38 wt % CaO, based on the total weight of the calcium aluminate cement. The calcium aluminate cements may further comprise up to 1.5 wt % MgO and up to 0.4 wt % SO₃, based on the total weight of the respective calcium aluminate cement. In certain embodiments, calcium sulfoaluminate cement has the chemical composition 5-10 wt % SiO₂, 15-25 wt % Al₂O₃, 1-5 wt % Fe₂O₃, 30-50 wt % CaO, 15-25 wt % SO₃, based on the total weight of the calcium sulfoaluminate cement. In particular, calcium sulfoaluminate cement may have the chemical composition 6 wt % SiO₂, 22 wt % Al₂O₃, 1 wt % Fe₂O₃, 35 wt % CaO, 16 wt % SO₃, based on the total weight of the calcium sulfoaluminate cement.

In some embodiments, the weight ratio CaO:SiO₂ in the levelling compound is 1:1 to 1.5:1. According to certain embodiments, the total content of Al₂O₃ in the levelling compound is <0.5 wt %, based on the dry weight of the levelling compound. In some embodiments, the total content of SO₃ in the levelling compound is 16.5 to 24 wt % and preferably 17.0 to 19.5 wt %, based on the dry weight of the levelling compound. In these embodiments, the above-mentioned advantages and effects are particularly pronounced. In this context, the indications “CaO”, “SiO₂”, “Al₂O₃” and “SO₃” refer to their contents in the binder. This means that the stated constituents “CaO”, “SiO₂”, “Al₂O₃” and/or “SO₃” may be at least partially or completely bound in a compound such as calcium carbonate or alpha calcium sulphate hemihydrate or a phase such as a C—S—H phase. Accordingly, the constituents mentioned may also be indicated as contents, e.g. by stating that the levelling compound comprises CaO contents and SiO₂ contents in a weight ratio of CaO:SiO₂ of 1:1 to 1.5:1 and/or that the total content of Al₂O₃ contents in the levelling compound is <0.5 wt %, based on the dry weight of the levelling compound and/or that the total content of SO₃ contents in the levelling compound is 16.5 to 24 wt % and preferably 17.0 to 19.5 wt %, based on the dry weight of the levelling compound.

According to certain embodiments, the additives are selected from the group consisting of dispersion powders, accelerators, retarders, rheology additives, hydrophobizing agents, air-entraining agents, defoamers and combinations thereof. In preferred embodiments, the additives are a combination of dispersion powder, retarder, rheology additives and accelerator. In some embodiments, the dispersion powder is selected from the group consisting of ethylene vinyl acetate copolymers, ethylene vinyl versatate copolymers, styrene acrylates, and combinations thereof. In preferred embodiments, the dispersion powder is ethylene vinyl acetate copolymer. In certain embodiments, the accelerator is selected from the group consisting of alkali metal hydrogen carbonates, alkali sulfates, CaSO₄ dihydrate, or combinations thereof. According to preferred embodiments, the accelerator is an alkali metal hydrogen carbonate. According to certain embodiments, the retarder is selected from the group consisting of fruit acids, phosphates, polyphosphates, alkali gluconates, saccharides, alkali tartrates or combinations thereof. The fruit acids may be tartaric acid or citric acid. In preferred embodiments, the retarder is sodium gluconate. In some embodiments, the hydrophobizing agent is a silane-based dispersion powder. Additionally, the hydrophobizing agent may comprise polyvinyl alcohol-based protective colloids. According to certain embodiments, the air-entraining agent is based on olefin sulfonates. In some embodiments, the defoamer is mineral oil based. In particular, the defoamer may comprise mineral oils supported on an inorganic support material such as CaCO₃. Furthermore, the defoamer may contain polyethylene glycol. According to certain embodiments, the rheology additives are selected from the group consisting of thickeners, plasticizers and combinations thereof. In particular, the rheology additives may be a combination of thickener and plasticizers. In some embodiments, the plasticizer is a comb polymer based on poly(meth)acrylic acid with polyethylene oxide side chains (PCEs, polycarboxylate ethers). In preferred embodiments, the plasticizer is polycarboxylate ether. According to some embodiments, the thickener is an amide-based polyelectrolyte with sulfonic acid groups. In these embodiments, the above-mentioned advantages and effects are particularly pronounced.

In some embodiments, the self-levelling compound comprises as additives 0.1 to 3.0 wt %, preferably 0.5 to 2.7 wt %, and more preferably 1.0 to 2.5 wt % dispersion powder, 0.05 to 2.00 wt %, preferably 0.10 to 1.00 wt %, and more preferably 0.20 to 0.60 wt % accelerator, 0.01 to 0.50 wt %, preferably 0.02 to 0.10 wt %, and more preferably 0.03 to 0.09 wt % retarder, 0.1 to 1.0 wt %, preferably 0.2 to 0.8 wt % and more preferably 0.4 to 0.6 wt % rheology additives, based on the dry weight of the self-levelling compound.

According to certain embodiments, the fillers are selected from the group consisting of sand, limestone powder, dolomite and combinations thereof. In preferred embodiments, the fillers are selected from the group consisting of sand, limestone powder and combinations thereof. According to further preferred embodiments, the fillers are a combination of sand and limestone powder. The sand may be quartz sand and/or have a particle size of 0.06 to 0.5 mm. In some embodiments, the limestone powder has a particle size of 0 to 90 μm. In certain embodiments, the particle size of the sand and/or limestone powder is determined via sieve residues. These embodiments further improve the application properties of the levelling compound.

In certain embodiments, the self-levelling compound has an efflux time of at most 70 s and/or a flow spread of at least 11 cm, measured with a flow cup with a 6 mm nozzle. In particular, the flow cup may be a flow cup according to DIN 53211:1987-06 with a 6 mm nozzle. According to some embodiments, the efflux time is determined according to DIN 53211:1987-06, wherein a mixed levelling compound is used instead of the lacquers, paints and similar coating materials measured in DIN 53211:1987-06 and wherein a flow cup with a 6 mm nozzle is used. In some embodiments, a mixed levelling compound is obtained by mixing the dry levelling compound with 18 to 22 wt % water, based on the dry weight of the levelling compound, optionally wherein the resulting mixture is homogenized for 30 to 60 s, in particular 45 s, with a laboratory stirrer at 18 to 20° C. Here, “dry” means that the levelling compound has not been mixed with water. According to certain embodiments, the flow cup is filled with the mixed levelling compound 30 seconds (s) after the levelling compound has been mixed. This means that between the mixing of the levelling compound and the filling of the flow cup there is a waiting time of 30 s. In some embodiments, the discharge of the mixed levelling compound from the flow cup is started 15 s after the flow cup has been filled with the mixed levelling compound. In the context of the present invention, the start of the discharge of the mixed levelling compound is also referred to as “flow start”. In particular, the efflux time may be determined according to the method described in the paragraph “Determination of the efflux time (in seconds (s)) and the flow spread (in centimeters (cm))” below.

According to some embodiments, the flow spread is determined subsequent to the determination of the efflux time, wherein the flow spread of the levelling compound is determined 4 min after the flow start. In certain embodiments, the flow spread is determined by carrying out the determination of the efflux time as described above, wherein the levelling compound flowing through the flow cup is collected on a plate covered with graph paper and 4 min after the flow start, the flow radius covered by the collected levelling compound on the glass plate is read from the graph paper. In particular, the flow spread may be determined according to the method described in the paragraph “Determination of the efflux time (in seconds (s)) and the flow spread (in centimeters (cm))” below.

According to some embodiments, the self-levelling compound is moisture resistant. For the purposes of the present invention, a levelling compound is considered to be moisture resistant if the values of the pull-off strength, flexural strength and compressive strength of the levelling compound after moisture storage (100% RH, 23° C.) for 28 days do not differ by more than 20% from the values of the pull-off strength, flexural strength and compressive strength of the levelling compound after normal storage (50% RH, 23° C.) for 28 days. In particular, “differ” means that the values of the pull-off strength, flexural strength and compressive strength of the levelling compound after moisture storage for 28 days are not reduced by more than 20% compared to the values of the pull-off strength, flexural strength and compressive strength of the levelling compound after normal storage for 28 days. For normal storage, a prismatic test specimen is produced in accordance with DIN EN 13892-1:2003-02 and stored at 23° C. and 50% RH, and for moisture storage, a prismatic test specimen is produced in accordance with DIN EN 13892-1:2003-02 and stored at 23° C. and 100% RH. In some embodiments, the levelling has a flexural strength of at least 7 N/mm², a compressive strength of at least 30 N/mm² and an pull-off strength of at least 1 N/mm² after 28 days of moisture storage. A detailed description of the determination methods for the pull-off strength, flexural strength and compressive strength after moisture storage and normal storage is given below.

In certain embodiments, the self-levelling compound has dimensional stability. For the purposes of the present invention, a levelling compound is considered to have dimensional stability if the levelling compound has a length change after normal storage for 28 days of <|0.3| mm/m and a length change after moisture storage for 28 days of <|0.3| mm/m. For normal storage, a prismatic test specimen is produced in accordance with DIN EN 13892-1:2003-02 and stored at 23° C. and 50% RH, and for moisture storage, a prismatic test specimen is produced in accordance with DIN EN 13892-1:2003-02 and stored at 23° C. and 100% RH. A detailed description of the determination method for the length change after moisture storage and normal storage is given below.

A second aspect of the present invention relates to a self-levelling compound comprising 30 to 40 wt % of a first binder, 10 to 20 wt % of a second binder, 40 to 59 wt % of at least one filler and >0 to 5 wt % of additives and/or other constituents based on the dry weight of the levelling compound. The weight ratio of the first binder to the second binder is 2:1 to 3.5:1. Furthermore, the first binder is alpha calcium sulphate hemihydrate and the second binder comprises 35 to 50 wt % CaO, 25 to 45 wt % SiO₂, 2 to 7 wt % water (H₂O), 0 to <1 wt % Fe₂O₃, 0 to <2 wt % A1202 and 0 to <2 wt % SO₃, based on the total weight of the second binder. In addition, the self-levelling compound is essentially free of Portland cement, calcium aluminate cement and calcium sulfoaluminate cement. Reference is made in its entirety to the above statements on the first aspect of the invention, which apply analogously here.

A third aspect of the present invention relates to a self-levelling compound comprising CaO and SiO₂ in a weight ratio CaO:SiO₂ of 1:1 to 1:1.5, A1202 in an amount of <0.5 wt % and SO₃ in an amount of 16.5 to 24 wt %. According to certain embodiments, the self-levelling compound comprises or consists essentially of 30 to 40 wt % of a first binder, 10 to 20 wt % of a second binder, 40 to 59 wt % of at least one filler and >0 to 5 wt % of additives and/or other constituents, based on the dry weight of the levelling compound. The weight ratio of the first binder to the second binder may be 2:1 to 3.5:1. Furthermore, the first binder may be alpha calcium sulphate hemihydrate. The second binder may comprise 35 to 50 wt % CaO, 25 to 45 wt % SiO₂, 2 to 7 wt % water (H₂O), 0 to <1 wt % Fe₂O₂, 0 to <2 wt % A1202 and 0 to <2 wt % SO₃, based on the total weight of the second binder. In addition, the self-levelling compound may be essentially free of Portland cement, calcium aluminate cement and calcium sulfoaluminate cement. In some embodiments, the levelling compound of the third aspect is a levelling compound according to the first and/or second aspect of the present invention. Reference is made in its entirety to the above statements on the first and second aspects of the invention, which apply analogously herein.

A fourth aspect of the present invention relates to the use of the levelling compound according to the first and/or second and/or third aspect of the present invention for levelling subfloors having a residual moisture content up to 5 CM % or 99% relative humidity (RH). In particular, the levelling compound according to the first aspect may be used for levelling indoor subfloors with a residual moisture content up to 5 CM % or 99% RH. In preferred embodiments, the residual moisture is 4 to 5 CM % or 90% RH to 99% RH. It is understood here that a concrete or screed surface adjacent to the overlying installation materials to be applied, such as the levelling compound according to the invention and/or the primer applied prior to levelling, must not contain any liquid water. In some embodiments, the subfloor is a concrete floor. According to certain embodiments, the subfloor is a screed. In some embodiments, the subfloor is a screed applied on a concrete floor. The term “concrete floor” (Betonboden) is defined in chapter 2.3 of TKB Merkblatt 8, Beurteilen und Vorbereiten von Untergründen für Bodenbelag- und Parkettarbeiten, March 2023. The term “screed” (Estrich) is defined in chapter 2.1 of TKB Merkblatt 8, Beurteilen und Vorbereiten von Untergründen für Bodenbelag- und Parkettarbeiten, March 2023. These definitions may be used in the context of the present invention. If the subfloor is a screed that is optionally applied on a concrete floor, the residual moisture may be measured in CM % using the CM method. In particular, the residual moisture in CM % may be determined in this case according to TKB Merkblatt 16, Anerkannte Regeln der Technik bei der CM-Messung, March 2016. If the subfloor is a screed that is optionally applied on a concrete floor, the residual moisture in % RH may be measured using the corresponding humidity method, abbreviated as KRL method. In particular, the residual moisture in % RH may be determined in this case according to TKB Merkblatt 18, KRL-Methode—Messung und Beurteilung der Feuchte von mineralischen Estrichen, February 2021. If the subfloor is a concrete floor, the residual moisture in % RH may be determined according to ASTM F2170-11. As described above, the levelling compound according to the invention is moisture-resistant and has dimensional stability and is therefore ideally suited for use on subfloors with high residual moisture. Reference is made in its entirety to the above statements on the first, second and third aspects of the invention, which apply analogously here.

### Manufacturing Method of the Self-Levelling Compound

The self-levelling compound according to the invention may be prepared by successive mixing of the above-mentioned constituents of the self-levelling compound according to the invention in any order or by simultaneous mixing in a mixing device customary for these purposes. By the constituents are meant in particular first binder, second binder, fillers and additives. The above statements on the first aspect of the invention apply analogously here.

### Manufacturing Method of the Second Binder

The second binder may be produced using the following method, for example. As starting materials, limestone (calcium carbonate, CaCO₃), calcium hydroxide (Ca(OH)₂) and/or calcium oxide (CaO) and silicon dioxide (SiO₂) and/or siliceous materials such as kaolin are mixed in the desired ratio and calcined at about 700° C. to 800° C. The calcined material is then subjected to hydrothermal treatment. The hydrothermal treatment may be conducted for 2 to 10 hours at 180° C. to 220° C. and in saturated water vapor, optionally with a pressure of 16 to 40 bar. After hydrothermal treatment, the product is dried (e.g. for 12 to 36 hours at 60° C. to 90° C. in a drying oven) and optionally ground into a powder.

Determination of the Efflux Time (in Seconds (s)) and the Flow Spread (in Centimeters (cm))

To determine the efflux time and the flow spread, an aluminum flow cup from the company Erichsen, model 243/II, with a 6 mm nozzle, a stopwatch with second display, a glass plate 30×30 cm or larger, graph paper, a 500 ml mixing vessel and a Vollrath laboratory stirrer EWTHV 0.5 with disc stirrer, diameter about 65 mm may be used. The graph paper should be waterproof (protective cover or laminated). For easier reading, concentric circles should be drawn at intervals of 1 cm and marked on the graph paper with the corresponding radius. The flow cup may be fixed on a stand at a height of 17.5 cm, which corresponds to a drop height of 11 cm for the mixed material. The stand foot should be outside the glass plate underneath so that there is enough space to spread the levelling compound. Then 500 g of levelling compound with 19 to 21.5 wt % water, based on the dry weight of the levelling compound, may be added to the mixing vessel and then homogenized for 45 s with the laboratory stirrer (mixing temperature about 18-20° C.). Then it may be proceeded as follows: The flow cup is mounted in a stand placed on the work surface. A piece of graph paper is placed underneath (the center of the paper must be vertically under the nozzle). A dry glass plate is placed on top. 30 s after mixing the levelling compound, the flow cup is filled to the brim and the nozzle is closed with a finger. Excess material is removed with a small glass plate or spatula. After a further 15 s from the start of filling, and after a total of 45 s after mixing the levelling compound, the “flow start” takes place: the finger is removed from the nozzle opening and a stopwatch is started with the other hand at the same time. Now it is observed how long the compound flows out of the cup. If there is a clear break in the discharge flow, the stopwatch is stopped. This time of thread breakage corresponds to the efflux time.

After determining the efflux time as described above, the flow radius covered by the collected levelling compound on the glass plate can be read off using the graph paper to measure the flow spread 4 minutes after the flow start. The flow radius is read at four positions offset by about 90° and averaged (reading accuracy 1 mm). The average value is rounded down to whole mm.

### Determination of Flexural Strength and Compressive Strength (in Newton Per Square Millimeter (N/mm²)) Under Normal Storage and Moisture Storage

To determine the flexural strength and compressive strength, prismatic test specimens (dimensions: 4 cm*4 cm*16 cm) were produced in accordance with DIN EN 13892-1:2003-02 and the strengths were determined after 28 days of normal storage or moisture storage in accordance with DIN EN 13892-2:2003-02. Normal storage means storage at 23° C. and 50% rH. For moisture storage, the prisms are produced according to DIN EN 13892-1: 2003-02 and stored 24 h later in a completely surrounding water bath (23° C., 100% rH).

### Determination of the Pull-Off Strength (in Newton Per Square Millimeter (N/mm²)) Under Normal Storage and Moisture Storage

The determination of the pull-off strength at normal storage (23° C./50% rH) was conducted according to DIN EN 13408:2002-06. For this purpose, a concrete slab (40 cm*40 cm*5 cm) was primed with a dispersion primer (e.g. UZIN PE 360) and 1.5 h later, a 3 mm layer of levelling compound was applied. After seven days drying time of the levelling compound, the pull-off strengths were determined. For this purpose, 50 mm*50 mm metal stamps were adhered to the levelling compound surface using 2-C epoxy mortar (e.g. Codex X-Tensive) and the pull-off strength was determined 24 h later using a suitable tensile tester (e.g. BPS Freundl, Wennigsen type Easy-M).

To determine the pull-off strength at moisture storage, a concrete slab conditioned by seven days of storage in water (23° C./100% rH) was removed from the water, dried on the surface with a towel and primed one hour later with a dispersion primer (e.g. UZIN PE 360). After a further hour's drying time, a 3 mm layer of the mixed levelling compound was applied. After 24 h, the surface of the levelling compound and the edges of the concrete slab were sealed with an epoxy resin primer (e.g. UZIN PE 460) and the surface sanded (e.g. UZIN pearl sand) to ensure sufficient adhesion for the pull-off stamps to be applied. After the epoxy resin primer (sealing) has hardened for 24 hours, the bottom of the slab is placed in water to a depth of about 3 cm so that the levelling compound is exposed to an accumulating permanent moisture load. Over the storage period of 28 days, it is to be ensured that the concrete slab is immersed in water to a depth of 3 cm throughout.

After 28 days, 50 mm*50 mm metal stamps are adhered to the surface of the levelling compound using 2-C epoxy mortar (e.g. Codex X-Tensive) and the pull-off strength is determined using a suitable tensile tester (e.g. BPS Freundl, Wennigsen type Easy-M).

Determination of the Length Change (in Millimeters Per Meter (mm/m)) During Normal and Moisture Storage

The measurement is conducted according to DIN EN 13872:2004-04 using one of the measuring devices described therein. The test specimens are demolded 24 hours after manufacture in a standard climate (23° C. 50% RH), the 0-value is measured and the test specimens are then stored for 28 days in the same way as described for the flexural and compression test. Prismatic test specimens measuring 4 cm*4 cm*16 cm were used instead of test specimens measuring 1 cm*4 cm*16 cm.

### Determination of the GWP Value (in kg CO₂-Equivalents/kg)

The GWP value of the levelling compounds was determined in accordance with DIN EN 15804:2012+A2:2019. A PCF (“Product Carbon Footprint”) of 0.615 kg CO₂-equivalents/kg product was assumed for the second binder.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 24162613.4, filed Mar. 11, 2024, are incorporated by reference herein.

### Examples

The present invention will now be described in detail with reference to several examples thereof. However, the invention is not limited to these examples.

### Manufacture of Self-Levelling Compounds

Table 1 shows formulations of self-levelling compounds. Example 1 is an exemplary formulation of a self-levelling compound according to the invention. The Comparative Examples 1 and 2 refer to commercially available self-levelling compounds based on gypsum or cement and thus represent the state of the art. The first binder used was alpha calcium sulphate hemihydrate. The second binder had the following composition: 39.43 wt % CaO, 38.86 wt % SiO₂, 0.18 wt % Fe₂O₃, 1.69 wt % Al₂O₃, 0.71 wt % 803, based on the total weight of the second binder. The data in Table 1 are in weight percent (wt %), based on the dry weight of the respective levelling compound.

TABLE 1
Compositions of exemplary self-levelling compounds.
The data are in weight percent (wt %), based on the
dry weight of the respective levelling compound.

| | | Comparative | Comparative |
|---|---|---|---|
| Components | Example 1 | Example 1 | Example 2 |
| Alumina cement | 0 | 2.5 | 8.5 |
| Portland cement | 0 | 0.9 | 25 |
| First binder | 36 | 45 | 2.5 |
| Second binder | 16 | 0 | 0 |
| Limestone powder | 22.5 | 30.6 | 15.74 |
| 0-90 μm | | | |
| Quartz sand | 23.04 | 18.54 | 46.3 |
| 0.06-0.5 mm | | | |
| Dispersion powder | 1.5 | 1.5 | 1.2 |
| Accelerator | 0.4 | 0.4 | 0.2 |
| Retarder | 0.06 | 0.06 | 0.06 |
| Rheology additives | 0.5 | 0.5 | 0.5 |
| Total | 100 | 100 | 100 |
| Mixing water | 21 | 22 | 20 |

### Testing the Moisture Resistance and Dimensional Stability of the Levelling Compounds

The flexural strengths, compressive strengths and pull-off strengths and the length changes of the levelling compounds in Example 1 and Comparative Examples 1 and 2 were each determined after 28 days of normal storage and moisture storage using the methods described in detail above. The amount of mixing water used for each levelling compound is shown in Table 1. The GWP values of the levelling compounds in Example 1 and Comparative Example 2 were determined using the method described above. The results are shown in Table 2.

TABLE 2
Presentation of the flexural strength, compressive strength and
pull-off strengths and dimensional changes of the levelling
compounds of Example 1 and Comparative Examples 1 and 2 after
28 days of normal storage and moisture storage. The percentage
deviation between normal storage and moisture storage is shown
in parentheses. The GWP values of the levelling compounds of
Example 1 and Comparative Example 2 are also shown.

| | | Comparative | Comparative |
|---|---|---|---|
| | Example 1 | Example 1 | Example 2 |
| Flexural strength [N/mm²] | 7 | 7 | 7 |
| after 28 days normal | | | |
| storage (23° C./50% RH) | | | |
| Flexural strength [N/mm²] | 7 | 2.4 | 7 |
| after 28 days moisture | (0%) | (−66%) | (0%) |
| storage (23° C./100% RH) | | | |
| Compressive strength | 35 | 35 | 32 |
| [N/mm²] after 28 days | | | |
| normal storage | | | |
| (23° C./50% RH) | | | |
| Compressive strength | 32 | 15 | 40 |
| [N/mm²] after 28 days | (−8.5%) | (−57%) | (+25%) |
| moisture storage | | | |
| (23° C./100% RH) | | | |
| Pull-off strength [N/mm²] | 2.0 | 1.8 | 1.8 |
| after 28 days normal | | | |
| storage (23° C./50% RH) | | | |
| Pull-off strength [N/mm²] | 2.0 | 0.1 | 1.8 |
| after 28 days moisture | (0%) | (−95%) | (0%) |
| storage (23° C./100% RH) | | | |
| Length change [mm/m] | \|0.198\| | \|0.063\| | \|0.288\| |
| after 28 days normal | | | |
| storage (23° C./50% RH) | | | |
| Length change [mm/m] | \|0.177\| | \|0.723\| | \|0.140\| |
| after 28 days moisture | | | |
| storage (23° C./100% RH) | | | |
| GWP [kg CO₂-eq/kg] | 0.24 | — | 0.36 |

As mentioned above, a levelling compound is described as moisture-resistant and dimensionally stable if, in particular, the following criteria are met:
A flexural and compressive strength class of at least C30 F7, both in normal and moisture storage, wherein the deviations in the values of the flexural and compressive strengths between the two types of storage are ≤20%.
Pull-off strengths ≥1.0 N/mm², both in normal and moisture storage, wherein the deviations in the values of the pull-off strengths between the two types of storage are ≤20%.
Length change ΔI<|0.3| mm/in, both in normal and moisture storage.

As can be seen from Table 2, conventional gypsum levelling compounds such as those in Comparative Example 1 suffer a loss of 50-70% in terms of flexural and compressive strength and a reduction of over 90% in pull-off strength when exposed to moisture. Conventional gypsum levelling compounds also tend to length changes of >|0.3| mm/in when exposed to moisture. Better moisture and dimensional stability can be achieved with cementitious levelling compounds such as those in Comparative Example 2.

The data in Table 2 show that the invention is the first to provide a levelling compound with calcium sulphate as the main binder that is dimensionally stable under the influence of moisture without Portland cement, calcium aluminate cement or calcium sulphoaluminate cement and is not subject to any significant reduction in flexural strength, compressive strength or pull-off strength. Gypsum-based levelling compounds from the prior art are not recommended for wet areas or on permanently moist subfloors due to their susceptibility to damage caused by moisture. The levelling compounds according to the invention now open up areas of application for rooms exposed to moisture for the first time without having to use cement-based levelling compounds.

Furthermore, the data from Table 2 show that the levelling compound according to the invention has a 33% lower GWP value than the levelling compound of Comparative Example 2. The invention thus provides a moisture-resistant and dimensionally stable levelling compound with a low GWP value.

The above embodiments, configurations and implementations can be combined with each other as desired, if appropriate. Other possible embodiments, configurations and implementations of the invention also include combinations of previously described features of the invention that are not explicitly mentioned. In particular, the skilled person will also add individual aspects as improvements or additions to the respective basic form of the present invention.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A self-levelling compound, consisting essentially of
30 to 40 wt % of a first binder;
10 to 20 wt % of a second binder;
40 to 59 wt % of at least one filler; and
>0 to 5 wt % of additives and/or other constituents, based on the dry weight of the self-levelling compound,
wherein the weight ratio of the first binder to the second binder is 2:1 to 3.5:1, and
wherein the first binder is alpha calcium sulfate hemihydrate and the second binder comprises:
35 to 50 wt % CaO;
25 to 45 wt %, SiO2;
2 to 7 wt % water;
0 to <1 wt % Fe2O3;
0 to <2 wt % Al2O3; and
0 to <2 wt % SO3, based on the total weight of the second binder.

2. The self-levelling compound according to claim 1, wherein at least a portion of the CaO, the SiO₂ and the water in the second binder is present as calcium hydrosilicate.

3. The self-levelling compound according to claim 1, wherein the second binder consists essentially of calcium hydrosilicates.

4. The self-levelling compound according to claim 1, wherein the levelling compound is essentially free of Portland cement, calcium aluminate cement and calcium sulfoaluminate cement.

5. The self-levelling compound according to claim 1, wherein the weight ratio CaO:SiO2 in the levelling compound is 1:1 to 1.5:1.

6. The self-levelling compound according to claim 1, wherein the second binder comprises 35 to 45 wt % CaO and 35 to 45 wt % SiO₂, based on the total weight of the second binder.

7. The self-levelling compound according to claim 1, wherein the total content of Al2O3 in the levelling compound is <0.5 wt %, based on the dry weight of the levelling compound.

8. The self-levelling compound according to claim 1, wherein the total content of SO₃ in the levelling compound is 17 to 19.5 wt %, based on the dry weight of the levelling compound.

9. The self-levelling compound according to claim 1, wherein the additives are selected from the group consisting of dispersion powders, accelerators, retarders, rheological additives, hydrophobizing agents, air-entraining agents, defoamers and combinations thereof.

10. The self-levelling compound according to claim 1, wherein the at least one filler is selected from the group consisting of sand, limestone powder, dolomite and combinations thereof.

11. The self-levelling compound according to claim 1, wherein the second binder is partially amorphous.

12. The self-levelling compound according to claim 1, wherein the levelling compound has an efflux time of at most 70 s, measured with a flow cup with a 6 mm nozzle according to DIN 53211:1987-06 and/or a flow spread of at least 11 cm.

13. The self-levelling compound according to claim 1, wherein the self-levelling compound is moisture-resistant, wherein a levelling compound is described as moisture-resistant if the values of the pull-off strength, flexural strength and compressive strength of the levelling compound after moisture storage for 28 days do not differ by more than 20% from the values of the pull-off strength, flexural strength and compressive strength of the levelling compound after normal storage for 28 days, wherein for normal storage a prismatic test specimen is prepared according to DIN EN 13892-1:2003-02 and stored at 23° C. and 50% RH and for moisture storage a prismatic test specimen is prepared according to DIN EN 13892-1:2003-02 and stored at 23° C. and 100% RH.

14. The self-levelling compound according to claim 1, wherein the self-levelling compound has dimensional stability, wherein a levelling compound is described as having dimensional stability if the levelling compound has a length change after normal storage for 28 days of <|0.3| mm/m and a length change after moisture storage for 28 days of <|0.3| mm/m, wherein for normal storage a prismatic test specimen is prepared according to DIN EN 13892-1:2003-02 and stored at 23° C. and 50% RH and for moisture storage a prismatic test specimen is prepared according to DIN EN 13892-1:2003-02 and stored at 23° C. and 100% RH.

15. Use of a levelling compound according to claim 1, in particular indoors, for levelling subfloors with a residual moisture content of up to 5 CM %, measured according to the CM method, or 99% RH, measured according to the KRL method or according to ASTM F2170-11.
